(19) United States
(12) Patent Application Publication
(10) Pub. No.: US 2007/0097233 A1
(43) Pub. Date: May 3, 2007

(54) Multiply effect

(76) Inventors: Robert P. Cazier, Fort Collins, CO (US); Murray D. Craig, Johnstown, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/264,061

(22) Filed: Oct. 31, 2005

(51) Int. Cl. H04N 5/262

(52) U.S. Cl. 348/239

(57) ABSTRACT

A user captures an original digital image, which is then selected for post-processing within the image capture device. The user selects a number of images from a defined list of multiples. The image capture device then down-samples the original image and duplicates the down-sampled image to create multiple tiles of the original image. Optionally, the tiled image may then be stored in a memory by the image capture device.

### BACKGROUND OF THE INVENTION

In the field of digital imaging, many photographers, both beginning and advanced, have a desire to make their images more personal. One method of doing this involves the use of image post-processing methods to add effects such as borders, color filters, and textures to their images. However, the application of many of these effects are typically accomplished through trial and error, and in some cases, the order in which effects are performed will be critical to the development of the final image. Users often are able to remember that they applied a number of effects to a given image, but are unable to precisely duplicate the series of effects on subsequent images.

Currently, the application of complex and powerful digital image effects requires the user to transfer raw images to a computer where (often expensive) software is used to apply the effects to their images. For users desiring to either directly couple their digital camera (or other image capture device) to a printer, there currently are only a very limited number of image effects available on camera, or within the printer firmware.

### SUMMARY OF THE INVENTION

A user captures an original digital image, which is then selected for post-processing within the image capture device. The user selects a number of images from a defined list of multiples. The image capture device then down-samples the original image and duplicates the down-sampled image to create multiple tiles of the original image. Optionally, the tiled image may then be stored in a memory by the image capture device.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is an example of a user captured original digital image from an example embodiment of an image capture device according to the present invention.

FIG. 2 is an example multiple image created from the original digital image of FIG. 1 from an example embodiment of an image capture device according to the present invention.

FIG. 3 is an example multiple image including a positive gutter width created from the original digital image of FIG. 1 from an example embodiment of an image capture device according to the present invention.

FIG. 4 is a flowchart of an example method for the creation of multiple images within an image capture device according to the present invention.

FIG. 5A is a front view of an example embodiment of an image capture device according to the present invention.

FIG. 5B is a rear view of an example embodiment of an image capture device according to the present invention from FIG. 5A.

### DETAILED DESCRIPTION

This description of the preferred embodiments is intended to be read in connection with the accompanying drawings, which are to be considered part of the entire written description of this invention. In the description, relative terms such as “lower,” “upper,” “horizontal,” “vertical,” “up,” “down,” “top,” “bottom,” “left,” and “right” as well as derivatives thereof (e.g., “horizontally,” “downwardly,” “upwardly,” etc.) should be construed to refer to the orientation as then described or as shown in the drawing figure under discussion. These relative terms are for convenience of description and normally are not intended to require a particular orientation. Terms concerning attachments, coupling and the like, such as “connected,” “coupled,” and “interconnected,” refer to a relationship wherein structures are secured or attached to one another either directly or indirectly through intervening structures, as well as both movable or rigid attachments or relationships, unless expressly described otherwise.

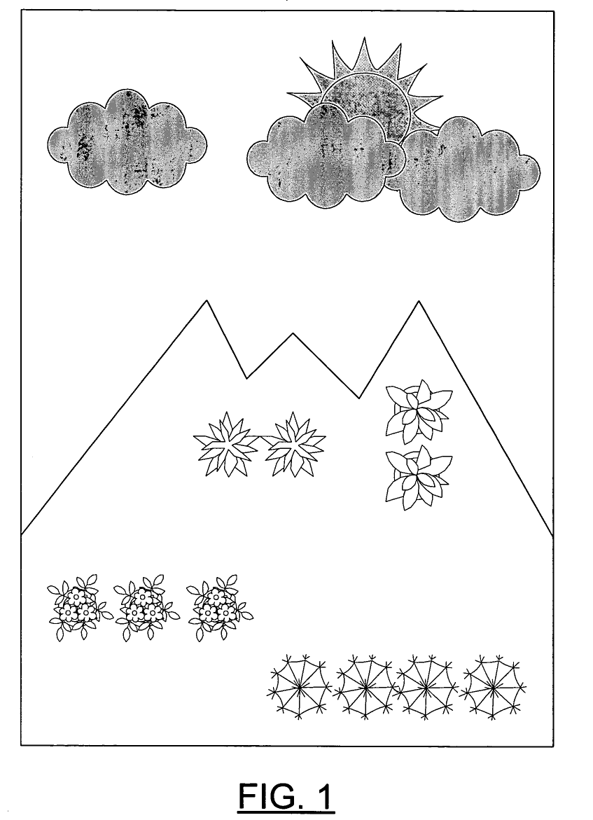

FIG. 1 is an example of a user captured original digital image from an example embodiment of an image capture device according to the present invention. An example original digital image 100 is shown. This original digital image 100 may be captured by a user using any of a variety of image capture devices, such as digital cameras or cell phones, within the scope of the present invention.

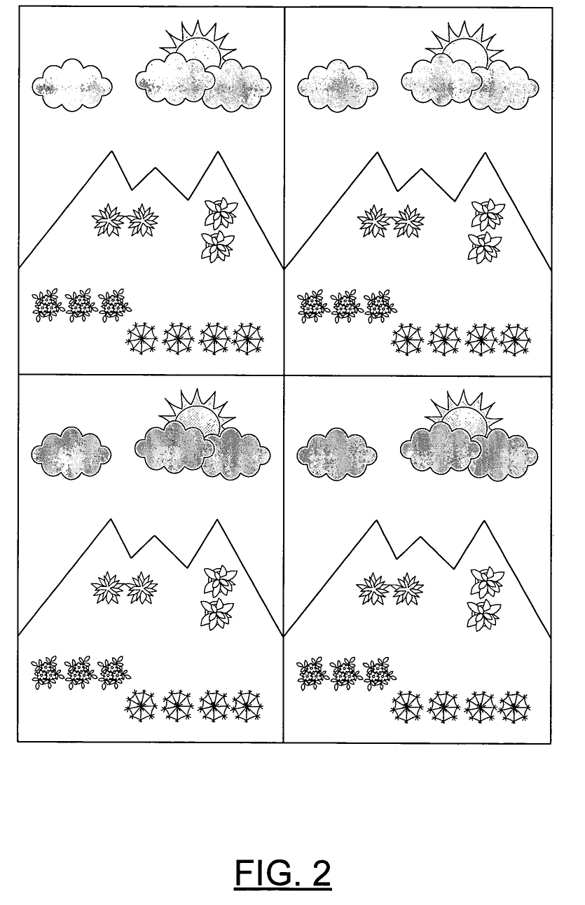

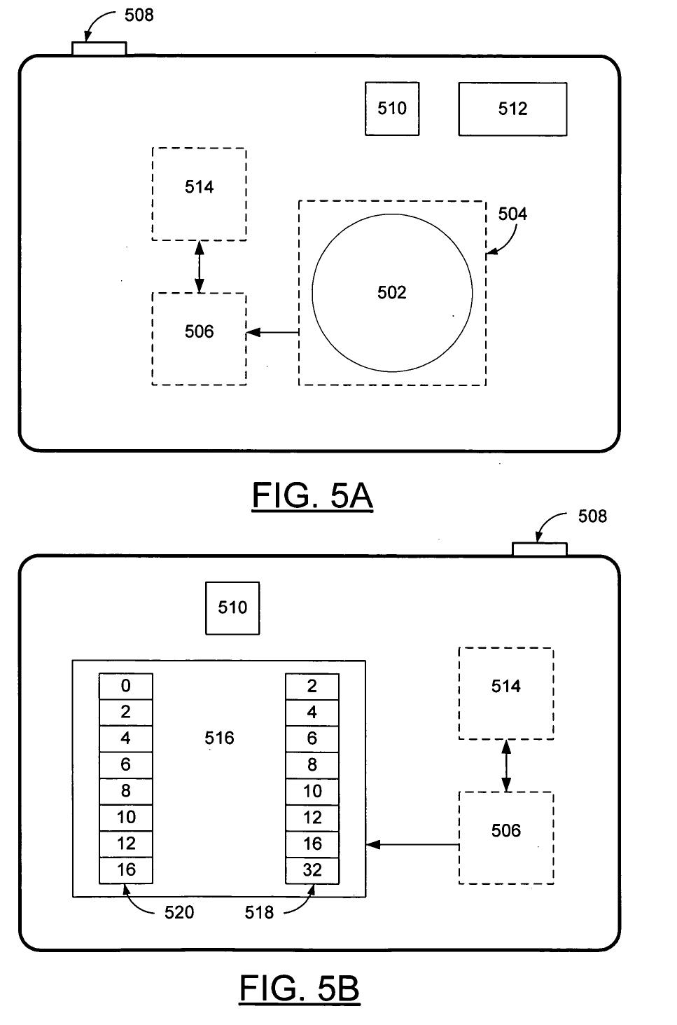

FIG. 2 is an example multiple image created from the original digital image of FIG. 1 from an example embodiment of an image capture device according to the present invention. In this example embodiment of the present invention a user has selected a multiple of 4 from an enumerated list of multiples provided to the user by the image capture device. In this example embodiment of the present invention, the original digital image 100 has been down-sampled by a factor of 2 in the horizontal dimension and a factor of 2 in the vertical dimension resulting in a down-sampled image 200, ¼ the size of the original digital image 100. This down-sampled image was then tiled twice on the horizontal axis and twice on the vertical axis, resulting in a tiled image of four smaller images. This example embodiment represents an x-axis tiling parameter of 2, and a y-axis tiling parameter of 2. Those of skill in the art will recognize that a very wide variety of multiples may be included on the enumerated list presented to the user, resulting in a wide variety of down-sampling amounts, and a wide variety of tiling parameters. Also, these multiples need not be limited to powers of two since, for example, a multiple of 6 may be offered to the user, and may result in a 2×3 or a 3×2 tiling all within the scope of the present invention. The tiling parameters may be calculated by a processor within the image capture device, or may be found on a look up table within a memory for faster results. Likewise, the down-sampling amount may be calculated by a processor within the image capture device, or may be found on a look up table within a memory for faster results. Please refer to FIG. 5 for a block diagram of an example embodiment of an image capture device according to the present invention including these features described above.

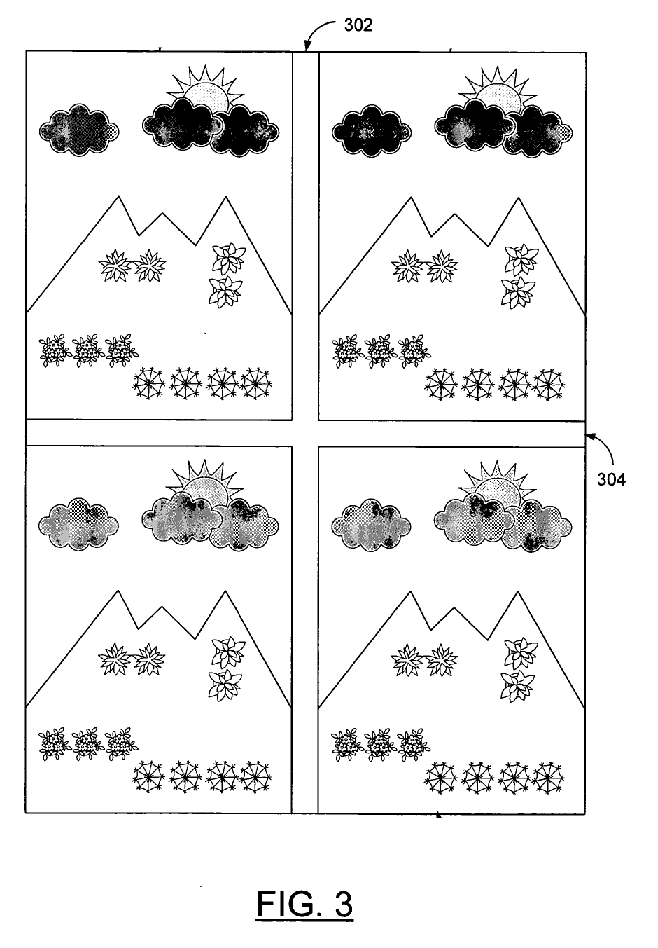

FIG. 3 is an example multiple image including a positive gutter width created from the original digital image of FIG. 1 from an example embodiment of an image capture device according to the present invention. In this example embodiment of the present invention a user has selected a multiple of 4 from an enumerated list of multiples provided to the user by the image capture device. The user has also selected a non-zero gutter width from a selection offered to the user by the image capture device. In some embodiments of the present invention, the user may be prompted to enter a numerical amount for the gutter width, while other embodiments may allow the user to select a gutter width from an enumerated list of possibilities. In this example embodiment of the present invention, the original digital image 100 has been down-sampled by a factor of 2 in the horizontal dimension and a factor of 2 in the vertical dimension resulting in a down-sampled image 300, ¼ the size of the original digital image 100. This down-sampled image was then tiled twice on the horizontal axis and twice on the vertical axis, resulting in a tiled image of four smaller images. This example embodiment represents an x-axis tiling parameter of 2, and a y-axis tiling parameter of 2. Gutters 302, 304 corresponding to the gutter width selected by the user are placed between the smaller images. Note that while this example embodiment of the present invention uses identical gutter widths for the vertical gutter 302 and the horizontal gutter 304, other embodiments may allow the user to choose differing gutter widths for the two types of gutters within the scope of the present invention. In the context of the present invention, the horizontal gutter runs parallel to the x-axis and separates rows tiled down-sampled images, while the vertical gutter runs parallel to the y-axis and separates columns of tiled down-sampled images. Also note that while the gutters in this example embodiment of the present invention are white, other embodiments may allow the user select a color to be used for the gutters.

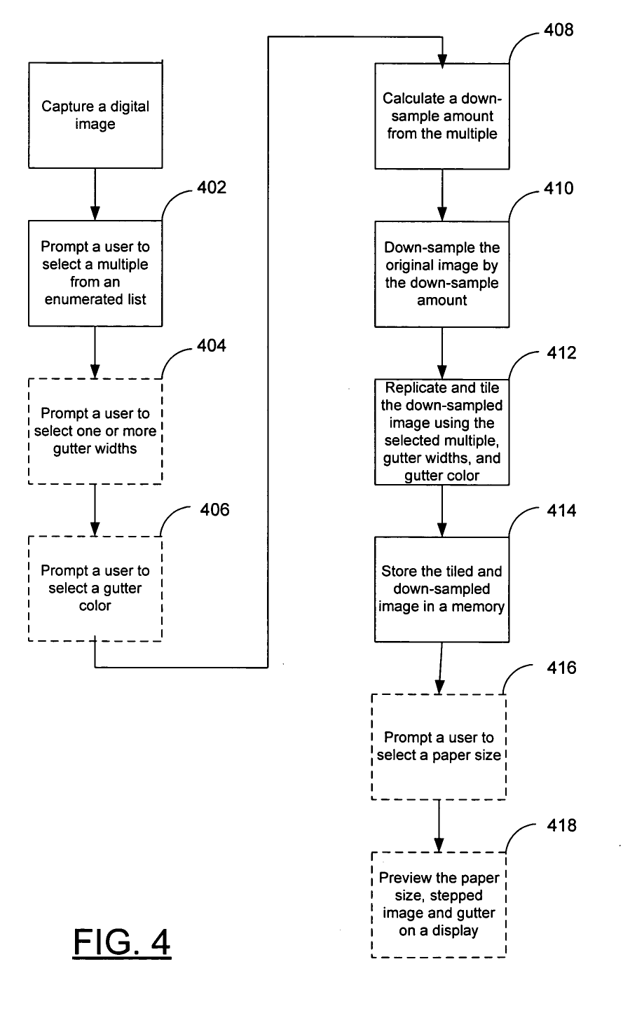

FIG. 4 is a flowchart of an example method for the creation of multiple images within an image capture device according to the present invention. In a step 400, an original digital image is captured. In a step 402, a user is prompted to select a multiple from an enumerated list. In the context of the present invention, “multiple” is used to designate the number of smaller tiled images desired in the final image. In an optional step 404, a user is prompted to select one or more gutter widths. In the context of the present invention, “gutter width” is used to designate the width of the gutter between the smaller tiled images. In an optional step 406, the user is prompted to select a gutter color. In a step 408, a down-sample amount is calculated from the selected multiple. In a step 410, the original image is down-sampled by the down-sample amount. In a step 412, the down-sampled image is multiplied and tiled using the selected multiple and gutter width. In a step 414, the tiled image is stored in a memory. In an optional step 416, the user is prompted to select a paper size. In an optional step 418, the paper size, stepped image, and gutter are previewed on a display.

FIG. 5A is a front view of an example embodiment of an image capture device according to the present invention. In this example embodiment of the present invention, a digital camera is designed including a body 500, a lens 502, an image sensor 504 configured to sense an image projected onto it by the lens 502, a memory 506, electrically coupled with the image sensor 504 configure to store image data, image metadata and custom effect files. The digital camera also includes a processor 514 configured to receive a multiply parameter selected by a user, optionally receive a gutter width selected by a user, calculate a down-sample amount, down-sample an original digital image, multiply and tile the down-sampled digital image, and store the tiled image in the memory 506. This example digital camera also includes a shutter button 508, a viewfinder 510, and a flash 512. In some example embodiments of the present invention, some or all of the memory 506 may be non-volatile memory.

FIG. 5B is a rear view of an example embodiment of the image capture device according to the present invention from FIG. 5A. This example digital camera also includes a display 516 (such as an LCD) electrically coupled to the memory 506 configured to display digital images and menus allowing a user to select a variety of multiply parameters. In this example embodiment of the present invention, a user interface is shown on the display 516. This user interface includes a list of multiples 518 and a list of gutter widths 520, allowing the user to select a multiple and a gutter width from each of the enumerated lists. Those of skill in the art will recognize that there are a wide variety of user interfaces possible allowing these selections, all within the scope of the present invention. For example, the multiple may be graphically presented to the user by displaying in real time the resultant down-sampled and stepped image with arrow buttons allowing the user to increase or decrease the multiple, without the user ever needing to know the numeric value of the multiple. Likewise, gutter width may be displayed to the user in real time, and interactively allow the user to increase and decrease gutter width until a pleasing result is achieved. Also, there are a wide variety of methods to allow a user to choose a gutter color known in the art. For example a user may be able to select the color of a portion of the image and have the gutter color set to the color of the selected pixel (or pixels).

Paper size may also be selected by the user in some embodiments of the present invention. The image capture device may offer the user a selection of paper sizes to choose from, and represent the paper size in the display as the stepped image is previewed for the user. This allows the user to interactively select a combination of paper size, multiple, gutter width, and gutter color all within the image capture device and the scope of the present invention.

The foregoing description of the present invention has been presented for purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. A method comprising the steps of:
a) capturing an original digital image with an image capture device;
b) prompting a user to select a multiple from an enumerated list;
c) calculating a down-sampling amount from the multiple selected by the user;
d) down-sampling the original digital image by the down-sampling amount; and
e) replicating and tiling the down-sampled image by the amount of the multiple selected by the user.

2. A method as recited in claim 1,
wherein the down-sampling amount is calculated from a look up table.

3. A method as recited in claim 1, further comprising the steps of:
f) allowing a user to select a gutter width; and
g) spacing the replicated and tiled images from each other by the distance of the selected gutter width.

4. A method as recited in claim 3, further comprising the steps of:
h) prompting a user to select a gutter color;
i) coloring the gutters in the final image with the selected gutter color.

5. A method as recited in claim 1, further comprising the steps of:
f) prompting the user to select a horizontal gutter width;
g) prompting the user to select a vertical gutter width; and
h) spacing rows of the replicated and tiled images from each other by the distance of the horizontal gutter width; and
i) spacing columns of the replicated and tiled images from each other by the distance of the vertical gutter width.

6. A method as recited in claim 5, further comprising the steps of:
j) prompting a user to select a gutter color;
k) coloring the gutters in the final image with the selected gutter color.

7. A method as recited in claim 1, further comprising the steps of:
i) prompting a user to select a paper size;
j) enlarging or reducing the replicated and tiled image to fit on the selected paper size.

8. A method as recited in claim 1,
i) previewing the stepped image on a display.

9. An image capture device comprising:
a memory configured to store digital images; and
a processor electrically coupled with said memory, configured to:
prompt a user for a multiple;
calculate a down-sampling amount from the multiple;
down-sampling an original image from said memory by said down-sampling amount;
replicate and tile the down-sampled image by the amount of the multiple selected by the user; and
store the replicated and tiled multiple image in said memory.

10. An image capture device as recited in claim 9,
wherein said processor is also configured to:
calculate the down-sample value from a look up table.

11. An image capture device as recited in claim 9,
wherein said processor is also configured to:
prompt the user for a gutter width; and
space the replicated and tiled images from each other by the distance of the selected gutter width.

12. An image capture device as recited in claim 11,
wherein said processor is also configured to:
prompt the user to select a gutter color; and
color the gutters in the final image with the selected gutter color.

13. An image capture device as recited in claim 9,
wherein said processor is also configured to:
prompt the user to select a paper size; and
enlarge or reduce the replicated and tiled image as needed to fit the selected paper size.

14. An image capture device as recited in claim 9,
wherein said processor is also configured to:
prompt the user to select a horizontal gutter width;
prompt the user to select a vertical gutter width; and
space rows of the replicated and tiled images from each other by the distance of the horizontal gutter width; and
space columns of the replicated and tiled images from each other by the distance of the vertical gutter width.

15. An image capture device as recited in claim 14,
wherein said processor is also configured to:
prompt the user to select a gutter color; and
color the gutters in the final image with the selected gutter color.

16. An image capture device as recited in claim 9, further comprising:
a display, configured to prompt the user, and to allow the user to select a multiple from an enumerated list.

17. An image capture device as recited in claim 16,
wherein said display is also configured to:
interactively display to the user a preview of the replicated and tiled image and allow the user to interactively select the multiple.

18. An image capture device as recited in claim 9, further comprising:
a display, configured to prompt the user, and to allow the user to select a gutter width from an enumerated list.

19. An image capture device as recited in claim 18,
wherein said display is also configured to:
interactively display to the user a preview of the replicated and tiled image and allow the user to interactively select the gutter width.

20. An image capture device as recited in claim 9, further comprising:
a display, configured to prompt the user, and to allow the user to select a gutter color from an enumerated list.

21. An image capture device as recited in claim 20,
wherein said display is also configured to:
interactively display to the user a preview of the replicated and tiled image and allow the user to interactively select the gutter color.

22. An image capture device as recited in claim 9, further comprising:
a display, configured to prompt the user, and to allow the user to select a paper size from an enumerated list.

23. An image capture device as recited in claim 22,
wherein said display is also configured to:
interactively display to the user a preview of the replicated and tiled image and allow the user to interactively select the paper size.

24. An image capture device as recited in claim 22,
wherein said processor is also configured to:
enlarge or reduce the replicated and tiled image to fit on the selected paper size.
